(19) United States
(12) Patent Application Publication
(10) Pub. No.: US 2004/0006615 A1
(43) Pub. Date: Jan. 8, 2004

(54) Method and apparatus for cerating proxy auto-configuration file

(75) Inventor: Charles P. Jackson, Mountain View, CA (US)

Correspondence Address: David B. Ritchie, Thelen Reid & Priest LLP, P.O. Box 640640, San Jose, CA, 95164-0640, US

(73) Assignee: Sun Microsystems, Inc., a Delaware Corporation

(21) Appl. No.: 10/190,406

(22) Filed: Jul. 2, 2002

(51) Int. Cl. G06F 15/177; G06F 15/173

(52) U.S. Cl. 709/223; 709/220

(57) ABSTRACT

A method creates a proxy auto-configuration file for a system including a plurality of proxy servers. The method includes accessing and performing a performance test on each of the plurality of proxy servers, and creating a proxy auto-configuration (PAC) file in response to the performing. The PAC file may be posted on a web server. The method may further include iteratively updating the PAC file by periodically conducting the accessing, the performing, and the creating. The creating the PAC file may include generating a list of a selected number of best-performing proxy servers among the plurality of proxy servers. The performing the performance test may include sending a command to fetch at least one selected web page, receiving the selected web page, and determining an amount of time required to fetch the selected web page.

### FIELD OF THE INVENTION

The present invention relates to proxy server configuration. More particularly, the present invention relates to a proxy auto-configuration file for a system including a plurality of proxy servers.

### BACKGROUND OF THE INVENTION

A proxy server is an application that provides access between two networks, typically a private internal computer network (intranet) and an external computer network such as the Internet. A proxy server is also referred to as a proxy or application level gateway. Proxy servers generally employ network address translation (NAT) and hide the internal network (inside a firewall) from the external network. A proxy server acts on behalf of a client to make a requests outside the client's network.

For example, as shown in FIG. 1, an organization (typically a private company) can put a proxy server 10 inside its firewall 12 to provide an internal client 14 with access to the Internet. When the client 14 attempts to access the Internet, the proxy server 10 intercepts the request and makes the request on behalf of the client 14. In a typical scenario, the internal client 14 is a client application program hosted on a computer system on the organization's LAN. The proxy server 10 receives a request from the client 14 to communicate with a remote server 16 outside the firewall 12, typically to fetch a web page from the server 16. The remote server 16 may be on the Internet (Internet server) or on other external network. The proxy server 10 evaluates the request, determines the location of the requested remote server 16, and communicates with it on behalf of the internal client 14. The proxy server 10 fetches web pages from the remote server 16 and returns them to the client 14.

When the remote server 16 returns a response, it is intercepted by the proxy server 10 and transferred to the client 14. The proxy server 10 can filter all incoming packets and discard any that are not related to an internal request (filtering), as well as approving the requested communication from the internal client 14 (access control). The proxy server 10 may also provide caching. Thus, the proxy server 10 provides the security and integrity of the private network, and also allows internal clients to go outside the firewall.

The proxy server 10 may have a client outside the firewall 12 via a virtual private network (VPN), i.e., a VPN client 18. In general, VPNs provide a secure connection through an unsecured network (such as the Internet) by either encrypting or encapsulating data for transmission. A wide variety of VPN technologies, including the Point-to-Point Tunneling Protocol (PPTP), Layer 2 Tunneling Protocol (L2TP), Multiprotocol Level Switching (MPLS), and IP Security (IPSec), provide such a secure connection to the internal network. A VPN creates a small “pocket” of the firewall so that the intranet virtually (temporally) extends to the VPN client 18. The VPN client 18 may be a remote user (e.g., a mobile worker of the company) or a remote site of the organization (e.g., a branch office of the company). Since the VPN client 18 is virtually “inside” the firewall 12, it needs to use the proxy server 10 when accessing the Internet or other outside networks.

Proxy servers require each client (such as a web browser program) to be configured so as to recognize and use the proxy servers. Specifically, the client needs to know how to communicate with the proxy, how to format requests to identify the remote servers, and the like. Conventionally, a network administrator of the LAN creates and posts a proxy auto-configuration (PAC) file on a system server employing a file sharing protocol, such as Network File System (NFS) or distributed file system, making the PAC file available to local clients on the LAN. Typically, when a client program is first installed or connected to the LAN, the client configures itself using the PAC file.

In an organization or company, multiple proxy servers may be deployed. For example, each corporate building or division may have its own proxy server. In such a case, typically, the most “convenient” proxy server is assigned to the local client based on the client's location, IP address, or the like. The assigned proxy server is sometimes “hard-coded,” i.e., the specific proxy is permanently assigned to a client. In order to change the assignment, it is necessary to manually change the proxy configuration.

However, when a growing number of people access the Internet through the proxy servers and network congestion mounts, one or more proxy servers may be overloaded, fail, or be taken offline. Thus, an assigned proxy server may be slow and/or its performance may be unreliable. In addition, VPN clients must configure a proxy server setting manually, since the conventional PAC file, which is typically NFS mounted, is not available through the VPN “pocket.”

### BRIEF DESCRIPTION OF THE INVENTION

A method creates a proxy auto-configuration file for a system including a plurality of proxy servers. The method includes accessing and performing a performance test on each of the plurality of proxy servers, and creating a proxy auto-configuration (PAC) file in response to the performing. The PAC file may be posted on a web server. The method may further include iteratively updating the PAC file by periodically conducting the accessing, the performing, and the creating. The creation of the PAC file may include generating a list of a selected number of best-performing proxy servers among the plurality of proxy servers. The performing the performance test may include sending a command to fetch at least one selected web page, receiving the selected web page, and determining an amount of time required to fetch the selected web page.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a diagram schematically illustrating a conventional computer network system employing a proxy server.

FIG. 2 is a diagram schematically illustrating a system including a plurality of proxy servers employing a proxy auto-configuration file in accordance with one embodiment of the present invention.

FIG. 3 is a diagram schematically illustrating a method for creating a proxy auto-configuration file for a system including a plurality of proxy servers in accordance with one embodiment of the present invention.

FIG. 4 is a diagram illustrating, in a tabular form, a result of an exemplary performance test on a set of proxy servers in accordance with one embodiment of the present invention.

FIG. 5 is a diagram showing an example of the list of best-performing proxy servers in accordance with one embodiment of the present invention.

FIG. 6 is a diagram illustrating a sample PAC file in accordance with one embodiment of the present invention.

FIG. 7 is a diagram schematically illustrating a method for handling a request from a client using the proxy auto-configuration file in accordance with one embodiment of the present invention.

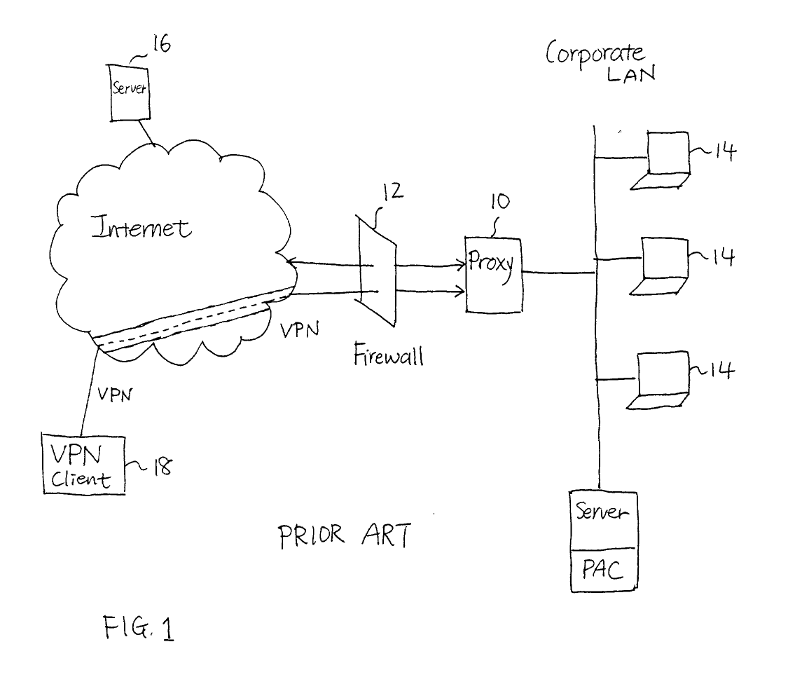

### DETAILED DESCRIPTION

Embodiments of the present invention are described herein in the context of a method and apparatus for creating a proxy auto-configuration file. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of operating systems, computing platforms, computer programs, and/or general purpose machines.

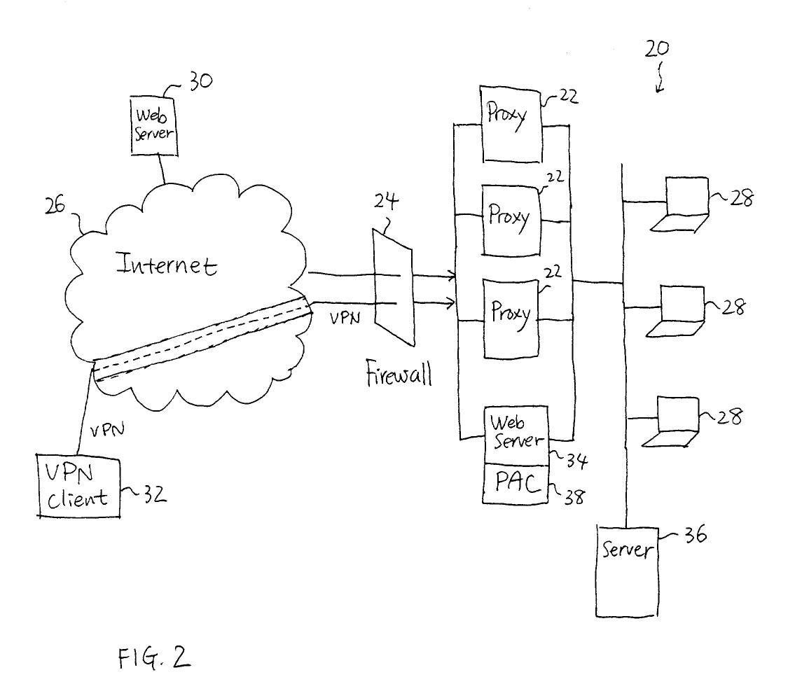

FIG. 2 schematically illustrates a computer network system including an internal network 20, an external network 26 such as the Internet, and a firewall 24 provided between the internal network 20 and the external network 26. The internal network 20 is typically a local area network (LAN) of an organization such as a corporation. However, the network 20 may be of any type of private network or intranet protected by a firewall. As shown in FIG. 2, a plurality of proxy servers 22 are also provided “between” the firewall and the network 20. It should be noted that the proxy servers may also be said that they “sit on the edge of the firewall” because the proxy servers can see inside the firewall 24 and outside thereof to the external network.

The proxy servers 22 provide local/internal clients 28 with access to the outside network 26 and to a remote server 30 on the outside network 26. A VPN client 32, such as remote users or remote sites of the organization, also uses the proxy servers 22 via a VPN connection as described above. A web server 34 is also provided. The web server 34 is accessible to the local clients 28 on the system 20 and to the VPN client 32 via a VPN connection. A PAC file 38 which is created in accordance with one embodiment of the present invention, as described below, is posted on the web server 34. The network 20 may also include one or more servers 36, which typically employ NFS protocol or any other distributed file system. In addition, the network 20 may include routers, switches and/or hubs (not shown) as necessary or desirable in accordance with a specific design of the network 20.

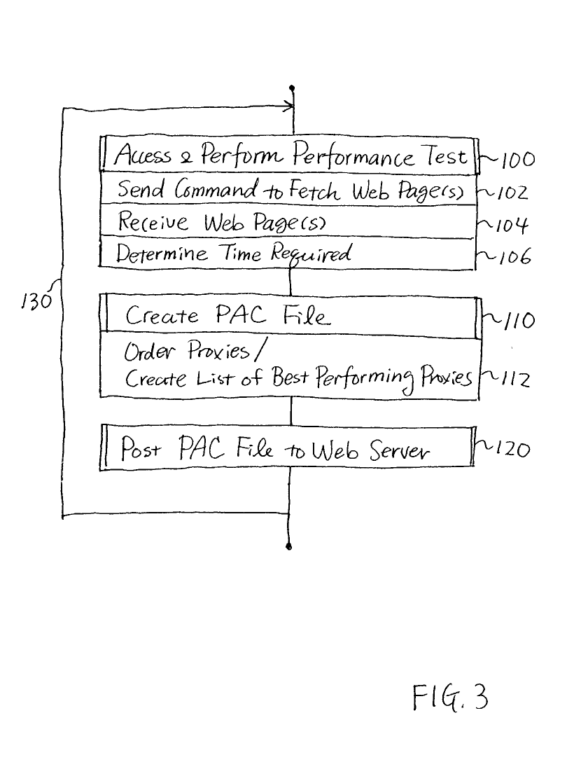

FIG. 3 schematically illustrates a method for creating a proxy auto-configuration (PAC) file for a system including a plurality of proxy servers in accordance with one embodiment of the present invention. First, the plurality of proxy servers are accessed and a performance test is performed on each of them (100). Such a performance test process is often referred to as a benchmark process. The proxy servers are benchmarked one by one using identical tests for each proxy server, and performance time is determined for each proxy server. Then a PAC file is created based on the result of the performance-tests (110). The proxy servers are sorted and ordered, and the best performing proxy server(s) are selected to construct a PAC file. The latest PAC file is placed on a web server (120).

The PAC file is iteratively updated (130) by periodically conducting the benchmark process (accessing the proxy servers and performing the performance test on each of them) (100), re-creating the PAC file (or re-generating the list of the best-performing proxy servers) (110) based on the benchmark result, and placing the latest PAC file on the web server (120). The update process 130 may be performed by automatically repeating the processes 100, 110, and 120 every specified time period. For example, the performance test is conducted every n minutes upon the proxy servers. The time period between two successive performance test may vary in accordance with the network design and configuration, for example, the number of proxy servers, the number of clients, the amount of traffic, the processing power of the computer, and the like. In accordance with one embodiment of the present invention, the benchmark process may be conducted every thirty (30) minutes. Such an iterative benchmark procedure may use scheduling utility program such as a cron, which is a UNIX utility program that regularly executes commands in a crontab file at a specified dates and times.

The benchmark process and creation/update of the PAC file may be conducted by any computer on the system other than the proxy servers to be benchmarked. For example, a computer program executing the benchmark process for the PAC file creation/update may reside on the same machine as the system server 36, or that of the web server 34 shown in FIG. 2. A computer may be dedicated to the benchmark process and the update of the PAC file. The plurality of the proxy servers may be all of the proxy servers known to the computer program, for example, a set of proxy servers available to a specific LAN. A list of such known/available proxy servers may be maintained. Although there is no theoretical maximum number of the set of proxy servers, the maximum number may be practically limited by the processing power of the computer executing the benchmark process.

The performance test may determine the fastest proxy server among the plurality of proxy servers. For example, as shown in FIG. 3, conducting the performance test 100 includes sending a command to fetch at least one selected web page (102) through a selected proxy server, receiving the selected web page (104), and determining an amount of time required to fetch the selected web page(s) (106). For example, a command-line web browsing utility, such as wget may be used, by employing any command-line web-browsing tool. The computer's realtime clock may be used to determine how long it takes to fetch a given web page through a selected proxy server. For example, a timing process may begin upon issuance of the fetch command, and end upon completion of the receiving the selected web page, in order to determine the fetch time using the selected proxy server. It should be noted that in order to obtain better time estimates, a command to fetch several web pages may be sent, and such fetching may be conducted more than once during a benchmark period.

FIG. 4 illustrates a result of an example of performance test performed on eleven (11) proxy servers. In order to benchmark the proxy servers, the following web pages (headers, text, and graphics) are fetched for each test:

http:/Hwww.sun.com/(a graphic-intensive page hosted in Colorado); and

http:H/www.nytimes.com/(a text-and-graphics intensive page, hosted in New York). Another web page hosted abroad, such as http://news.bbc.co.uk/(a text-and-graphics intensive page, hosted in United Kingdom) may also be used for the performance test. The result of the performance test may be stored as a list, as shown in FIG. 4, containing arrays of proxy server names and the time required (in seconds) for the page-fetch though the corresponding proxy servers. The benchmark procedure is repeated for each proxy server in the list. It should be noted that the web pages shown above are by way of example and are not intended to be exhaustive or limiting in any way. Those of ordinary skill in the art will now realize that other mechanism (different web pages, files, URLs, and the like) may be used to perform the benchmark testing.

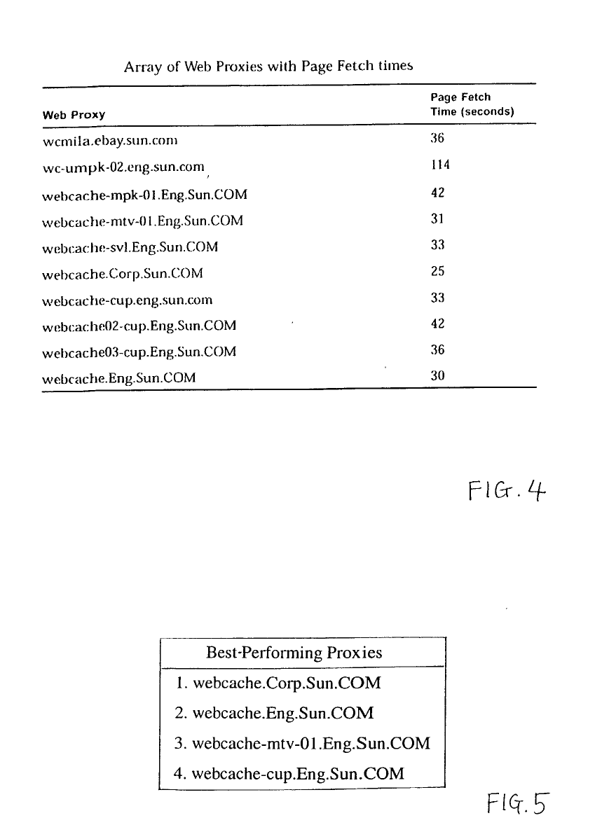

Referring back to FIG. 3, the PAC file is created in response to performing the performance test (110). Creating the PAC file may include generating a list of a selected number of best-performing proxy servers among the plurality of proxy servers (112). FIG. 5 illustrates an example of the list of the best-performing proxy servers. The number of the listed best-performing proxy servers may be one or more, and it may be four in accordance with one embodiment of the present invention. The list of the best-performing proxy servers may be created in the following manner. Once each proxy server has been benchmarked, the array of the performance test result (FIG. 4) is sorted by page-fetch time, thereby ordering the proxy servers in accordance with their time performance. Then a selected number of best-performing proxy servers are chosen from the top of the ordered list. In the example in FIGS. 4 and 5, the best-performing proxy is webcache.Corp.Sun.COM, having a page-fetch time of 25 seconds.

Once the fastest proxy server has been determined and the list of the best-performing proxy servers is obtained, the information is assembled into a PAC file to be read-in by the clients, including VPN clients, using a web browser. In the case where all of the clients are local, i.e., inside the firewall, the created PAC file may be stored in a system server such as the server 36. However, in order to make the PAC file available to VPN clients accessing from outside of the firewall, the PAC file is posted on a web server in accordance with one embodiment of the present invention. For example, the Multipurpose Internet Mail Extensions (MIME) type: application/x-ns-proxy-autoconfig is added to the web server configuration file so as to allow the PAC file to be posted through web sites. Once posted in this manner, the PAC file may be accessed via a Uniform Resource Locator (URL) assigned to the PAC file. The PAC file posted via a URL (instead of through NFS file mounts) may be accessed through corporate VPNs as well as the corporate internets.

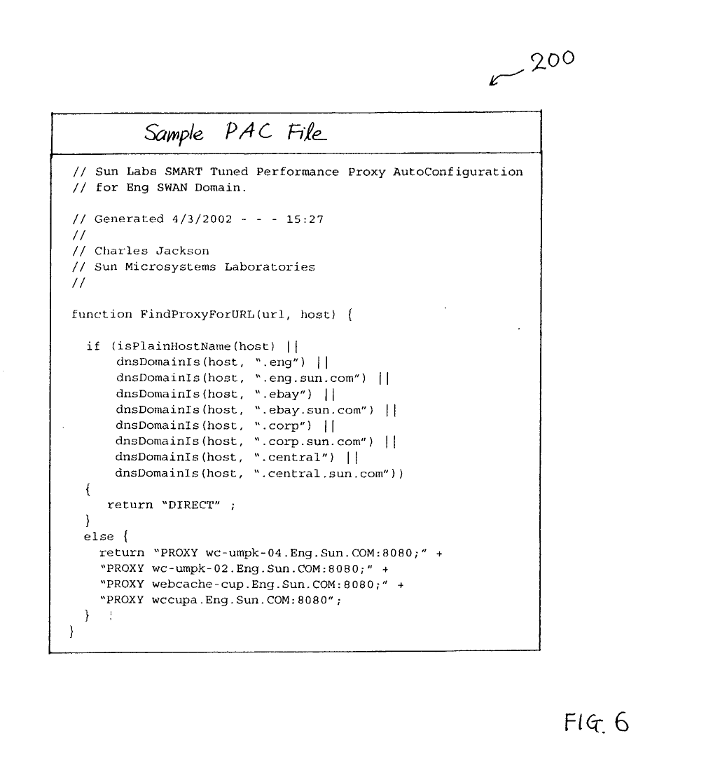

A standard and conventional PAC file is a JavaScript program that assigns a proxy server to the client, for example, a web browser, typically based on a user's IP address. Conventional PAC files assign a proxy server to an IP address based on some predetermined manner, such as physical location, regardless of performance of the proxy servers, as described above. In accordance with one embodiment of the present invention, the PAC file assigns one or more proxy servers based on their performance, i.e., the best-performing proxy server(s) selected from among the available proxy servers to the system. FIG. 6 illustrates an example of the PAC file 200 that is generated by one embodiment of the present invention. However, it should be noted that the sample PAC file 200 is by way of example and is not intended to be exhaustive or limiting in any way.

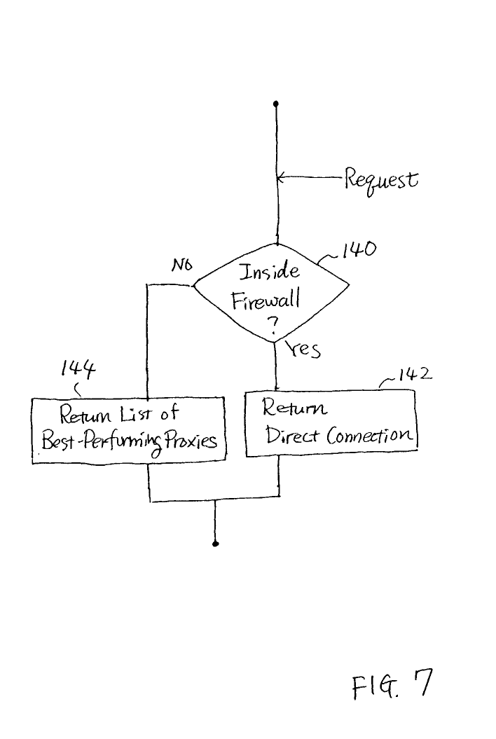

FIG. 7 schematically illustrates the process the created PAC file handles requests from clients in accordance with one embodiment of the present invention. When a user (either local or remote) makes a request, through the corresponding client (typically a web browser), for accessing a web server, the client first accesses to the PAC file. First, code in the PAC file determines if the requested web page is located within the firewall (140). If the requested web page is within the firewall, no proxy is necessary, and thus a direct connection is returned to the client (142) and all proxy servers are bypassed. For example, in the sample PAC file 200 shown in FIG. 6, such an internal access request is handled by the first section of the PAC file 200, and a DIRECT connection is returned to the client. If the web page being fetched is hosted on a web server outside the firewall (handled by “else” section of the PAC file 200), the selected number of the fastest proxies (a list of best performing proxies) are returned to the client (144).

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A method for creating a proxy auto-configuration file for a system including a plurality of proxy servers, said method comprising:
accessing and performing a performance test on each of the plurality of proxy servers; and
creating a proxy auto-configuration file in response to said performing.

2. A method in accordance with claim 1, further comprising:
iteratively updating the proxy auto-configuration file by periodically conducting said accessing, said performing, and said creating.

3. A method in accordance with claim 2 wherein said creating includes:
generating a list of a selected number of best-performing proxy servers among the plurality of proxy servers.

4. A method in accordance with claim 3, further comprising:
returning the list to a client in response to a request from the client.

5. A method in accordance with claim 1, further comprising:
posting the proxy auto-configuration file on a web server.

6. A method in accordance with claim 1 wherein said performing includes:
sending a command to fetch at least one selected web page;
receiving the selected web page; and
determining an amount of time required to fetch the selected web page.

7. A method in accordance with claim 6 wherein said determining includes:
beginning a timing process upon issuance of the fetch command; and
ending the timing process upon completion of said receiving the selected web page.

8. A method in accordance with claim 1 wherein the plurality of proxy servers are within a firewall.

9. A method in accordance with claim 8, further comprising:
returning, in response to a request from a client, a list of a selected number of best-performing proxy servers among the plurality of proxy servers if a requested web page is on a web server outside of the firewall; and
returning, in response to a request from a client, a direct connection to a requested web page if the requested web page is on a web server inside the firewall.

10. A method for creating a proxy auto-configuration file for a system including a plurality of proxy servers, said method comprising:
accessing and performing a performance test on each of the plurality of proxy servers; and
creating a proxy auto-configuration file in response to said performing, the proxy auto-configuration file including a list of a selected number of best-performing proxy servers among the plurality of proxy servers.

11. A method in accordance with claim 10, further comprising:
iteratively updating the list by periodically conducting said accessing, said performing, and said creating.

12. A method in accordance with claim 10 wherein said creating includes:
ordering the plurality of proxy servers in response to said performing.

13. A method in accordance with claim 10, further comprising:
returning the list to a client in response to a request from the client.

14. A method in accordance with claim 10, further comprising:
posting the proxy auto-configuration file on a web server.

15. A method in accordance with claim 10 wherein said performing includes:
sending a command to fetch at least one selected web page;
receiving the selected web page; and
determining an amount of time required to fetch the selected web page.

16. A method in accordance with claim 15 wherein said determining includes:
beginning a timing process upon issuance of the fetch command; and
ending the timing process upon completion of said receiving the selected web page.

17. A method in accordance with claim 10 wherein the plurality of proxy servers are within a firewall.

18. A method in accordance with claim 17, further comprising:
returning the list in response to a request from a client, if a requested web page is on a web server outside of the firewall; and
returning a direct connection to a requested web page in response to a request from a client, if the requested web page is on a web server inside the firewall.

19. An apparatus for creating a proxy auto-configuration file for a system including a plurality of proxy servers, said apparatus comprising:
means for accessing and performing a performance test on the plurality of proxy servers; and
means for creating a proxy auto-configuration file in response to said performing.

20. An apparatus in accordance with claim 19, further comprising:
means for iteratively updating the proxy auto-configuration file by periodically executing said means for accessing and performing, and said means for creating.

21. An apparatus in accordance with claim 20 wherein said means for creating includes:
means for generating a list of a selected number of best-performing proxy servers among the plurality of proxy servers.

22. An apparatus in accordance with claim 21, further comprising:
means for returning the list to a client in response to a request from the client.

23. An apparatus in accordance with claim 19, further comprising:
means for posting the proxy auto-configuration file on a web server.

24. An apparatus in accordance with claim 19 wherein said means for accessing and performing includes:
means for sending a command to fetch at least one selected web page;
means for receiving the selected web page; and
means for determining an amount of time required to fetch the selected web page.

25. An apparatus in accordance with claim 24 wherein said means for determining includes:
means for beginning a timing process upon issuance of the fetch command; and
means for ending the timing process upon completion of said receiving the selected web page.

26. An apparatus in accordance with claim 19, further comprising:
means for returning, in response to a request from a client, a list of a selected number of best-performing proxy servers among the plurality of proxy servers if a requested web page is on a web server outside of a firewall; and
means for returning, in response to a request from a client, a direct connection to a requested web page if the requested web page is on a web server inside the firewall.

27. An apparatus for creating a proxy auto-configuration file for a system including a plurality of proxy servers, said apparatus comprising:
means for accessing and performing a performance test on each of the plurality of proxy servers; and
means for creating a proxy auto-configuration file in response to said performing, the proxy auto-configuration file including a list of a selected number of best-performing proxy servers among the plurality of proxy servers.

28. An apparatus in accordance with claim 27, further comprising:
means for iteratively updating the list by periodically executing said means for accessing and performing, and said means for creating.

29. An apparatus in accordance with claim 27 wherein said means for creating includes:
means for ordering the plurality of proxy servers in response to said performing.

30. An apparatus in accordance with claim 27, further comprising:
means for returning the list to a client in response to a request from the client.

31. An apparatus in accordance with claim 27, further comprising:
means for posting the proxy auto-configuration file on a web server.

32. An apparatus in accordance with claim 27 wherein said means for accessing and performing includes:
means for sending a command to fetch at least one selected web page;
means for receiving the selected web page; and
means for determining an amount of time required to fetch the selected web page.

33. An apparatus in accordance with claim 32 wherein said means for determining includes:
means for beginning a timing process upon issuance of the fetch command; and
means for ending the timing process upon completion of said receiving the selected web page.

34. An apparatus in accordance with claim 27, further comprising:
means for returning the list in response to a request from a client, if a requested web page is on a web server outside of a firewall; and
means for returning a direct connection to a requested web page in response to a request from a client, if the requested web page is on a web server inside the firewall.

35. A program storage device readable by a machine, tangibly embodying a program of instructions executable by the machine to perform a method for creating a proxy auto-configuration file for a system including a plurality of proxy servers, said method comprising:
accessing and performing a performance test on the plurality of proxy servers; and
creating a proxy auto-configuration file in response to said performing.

36. A program storage device in accordance with claim 35 wherein said method further comprising:
iteratively updating the proxy auto-configuration file by periodically conducting said accessing, said performing, and said creating.

37. A program storage device readable by a machine, tangibly embodying a program of instructions executable by the machine to perform a method for creating a proxy auto-configuration file for a system including a plurality of proxy servers, said method comprising:
accessing and performing a performance test on each of the plurality of proxy servers; and
creating a proxy auto-configuration file in response to said performing, the proxy auto-configuration file including a list of a selected number of best-performing proxy servers among the plurality of proxy servers.
